(19) United States
(12) Patent Application Publication
(10) Pub. No.: US 2011/0173022 A1
(43) Pub. Date: Jul. 14, 2011

(54) Systems and Methods for Electronic Health Management

(76) Inventors: Gregg L. Mayer, El Cerrito, CA (US); Philip Joseph Eulie, Rancho Cordova, CA (US)

(21) Appl. No.: 12/987,136

(22) Filed: Jan. 9, 2011

Related U.S. Application Data
(62) Division of application No. 09/861,059, filed on May 17, 2001.

(51) Int. Cl. G06Q 50/00; G06Q 10/00

(52) U.S. Cl. 705/2

(57) ABSTRACT

The present invention provides systems and methods for managing patient healthcare from a variety of goal-oriented perspectives. Patients are enabled not only to store and maintain their complete medical, dental or other health records, but also to utilize the data of other patients to maximize the benefit and efficiency of a patient's overall healthcare. The present invention comprises a set of software tools that can be used by a consumer (patient or individual) to take charge of his or her own medical or health care. Systems and methods of the present invention enable a patient(s) to store, research and track healthcare provider information maintained in a dynamic healthcare database. Software tools encompassed within the scope of the present invention allow patients to access, analyze, and utilize stored medical provider data to manage their medical or health care in an unique, personalized and efficient manner that affords the greatest possible benefit to an individual or a patient.

### RELATED APPLICATIONS

This Application claims priority of U.S. Provisional Application No. 60/205,514 filed May 19, 2000, and U.S. patent application Ser. No. 09/861,059 filed May 19, 2001, both of which is are hereby incorporated by reference in its their entirety.

### BACKGROUND OF THE INVENTION

1. Field of the Invention

This invention relates to patient healthcare and systems for managing its delivery and administration. More particularly, the invention relates to computerized tools for tracking, maintaining and managing various aspects of patients' healthcare.

2. General Background and State of the Art

Typically, health care providers (such as physicians and other professionals) or healthcare payers (such as HMOs and health insurance companies) are the only parties in control of actively managing an individual's healthcare. Unfortunately, the methods and focus of such parties are motivated by population and spending management, rather than being focused towards managing the specific healthcare needs of the individuals.

For example, while it is true that healthcare payers and healthcare providers may maintain databases of patient healthcare data, such data is typically stored for legal or monetary reimbursement purposes. We are not aware of any system which maintains complete records of an individual's health care information for the purpose of managing that individual's healthcare according to a health-related, patient centered incentive.

Moreover, we are not aware of a system that stores and maintains a complete central database of an individual's own health care information. Typically, each payer and provider has their own database of patient encounter data. Unfortunately, however, these are driven by reimbursement and legal needs.

Currently, patients are the ideal parties capable of gathering and storing a complete set of their own health care information from all providers and encounters. They also have the strongest incentive to do so, through motivation to improve the efficacy of their own health care, and that of their family members. However, systems and methods directed to such a purpose are not available to patients. This makes the task of maintaining one's own health care and health care information burdensome and inefficient. Moreover, methods for analyzing and utilizing a patient's own health care information for the patient's own benefit are not currently available to patients for directing their own health care management.

Furthermore, patients have difficulty in understanding what their routine and preventive healthcare needs are, and what they should be. They are typically at the mercy of their provider, who may or may not recommend the latest in medical standards for, for example, prevention and routine care as promulgated by academic and/or medical societies. Therefore, availability of individual health care history and patient needs in a central database, along with the capability to match this information against patient demographics and specific medical treatment and/or diagnostic standards as stored in the above-mentioned database of health care information for a patient, and delivery of this information by the internet, provides patients with the ability to manage their own preventive and routine health care. This also allows the patient and health care practitioners to know that these individuals are receiving efficient, reliable and consistent state of the art health care and health care management.

Another problem faced by patients is that of identifying and selecting satisfactory physicians or providers. Typically, patients are forced to make these important decisions almost blindly, such as by selecting a name from a provider directory or being in receipt of a referral from a primary care physician who likely does little more than select a name from the patient's provider directory. Unfortunately, such selections are frequently based on little more than the addresses listed along with the provider names in the directory. Patients may be able to identify geographically-suited physicians in such directories, but generally lack the power, knowledge, and ability required to make more insightful decisions.

Yet another problem encountered by patients is that of choosing health insurance plans and policies. Although much of these decisions is controlled by patients' employers, patients are normally able to select from various levels of coverage and, sometimes, from various health insurance providers. Because different health plans operate according to different schemas, some plans will be more beneficial to a patient than others. Identifying the optimum plan for any particular patient, however, is difficult, and patients usually lack the information they would need to make a carefully calculated decision to bring them the greatest financial benefit. Therefore, these decisions are frequently based upon spending estimations, guesses and thin estimations, with little or no optimization calculations bringing weight to the decisions.

In general, health care maintenance methodologies to date fail to provide individuals with the degree of control and direct involvement over one's own healthcare that can be provided from a patient-centric resource. Accordingly, one of the objects of the present invention is to provide systems and methods for the novel management and administration of patients' healthcare. Therefore, the invention includes computerized tools for tracking, maintaining and managing various aspects of patients' healthcare which have previously been unavailable to the patient or consumer population.

### INVENTION SUMMARY

The present invention comprises a set of software tools that can be used by a consumer (patient or individual) to take charge of his or her own medical or health care. Systems and methods of the present invention enable a patient(s) to store, maintain and track his/her own medical data. Software tools encompassed within the scope of the present invention allow patients to access, analyze, and utilize their stored medical data to manage their medical or health care in an efficient manner that affords the greatest possible benefit to an individual or a patient.

More specifically, the present invention provides patients with systems and methods for managing their healthcare from a variety of goal-oriented perspectives. That is, patients are enabled not only to store and maintain their complete medical, dental or other health records, but also to utilize that data to maximize the benefit and efficiency of their overall healthcare. This allows a multi-dimensional approach to the use of patient health information and management of patient healthcare. These benefits may be manifested in a variety of different areas of the patient's overall or total healthcare management.

For example, in one embodiment of the invention, personal guidance is provided to patients according to their personalized symptoms, demographics and/or medical or health history. In another embodiment of the invention, preventive health measures performed to date are assessed, tabulated, compared to accepted medical standards, including evidence-based medicine standards promulgated by academic, governmental, consumer representative, affinity groups, medical societies (or other such organizations or resources known in the art), evaluated against the patient's specific health care history, and a summary of needed measures are suggested and their scheduling and delivery managed for patients.

In a further embodiment of the invention, a patient's health is actively assessed and personalized treatment suggestions are provided either to the patient or to his or her physician or healthcare provider. In still another embodiment of the invention, pre-screening reports are efficiently produced for a patient's physician or healthcare provider prior to an office visit. In yet another embodiment of the invention, physician recommendations are determined and presented to patients according to a variety of patient-determined selection criteria. In yet another embodiment of the invention a patient's healthcare coverage is financially optimized. In yet another embodiment of the invention, a patient can use other patients' satisfaction ratings of their providers to select a provider that is more likely to be satisfactory to their own medical needs, demographic characteristics, and/or individual preferences. In additional embodiments of the invention, various tools are also provided to further expand upon one or more user's ability to manage numerous aspects of his/her health care needs or his/her access to health care, aided by centralized set of patient health care information and health care encounters.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. 1 illustrates component features of a method for managing patient healthcare.

FIG. 2 illustrates component features of a method for managing patient healthcare.

FIG. 3 illustrates component features of a method for optimizing the financial benefit of a patient's health insurance benefits.

FIG. 4 illustrates a computer-implemented system used for recommending a healthcare professional to a patient.

FIG. 5 illustrates component features of a method for managing patient healthcare.

FIG. 6 illustrates component features of a method for managing patient healthcare.

### DETAILED DESCRIPTION OF THE PREFERRED EMBODIMENTS

The present invention comprises a set of software tools that can be used by a consumer (patient) to manage his or her own health care or health records. Systems and methods of the present invention enable a patient(s) to store, maintain and track his/her own medical data. Software tools encompassed within the scope of the present invention allow patients to access, analyze, and utilize their stored medical data to manage their healthcare in an efficient manner that affords the greatest possible benefit to the patient.

More specifically, the present invention provides patients with systems and methods for managing their healthcare from a variety of goal-oriented perspectives. Therefore, the present invention is capable of combining general preventive care needs with chronic disease preventive care needs specific for an individual or patient. In the following description of the preferred embodiments reference is made to the accompanying drawings which form the part thereof, and in which are shown by way of illustration specific embodiments in which the invention may be practiced.

It is to be understood that other embodiments may be utilized and structural and functional changes may be made without departing from the scope of the present invention. It should be understood, that the term “him” or “her” as used herein is used in the generic sense, and is not limited to a patient or individual for whom a specific medical or health database information relates, but is also intended to include consumers or individuals who have guardianship or other legal rights over a specific patient's health care management.

For example, a patient of the present invention can include a minor or a person who has or may have some degree of mental incapacity. Therefore, for example, the “user” accessing the software tools or inputting data of the present invention would be a parent or legal guardian of that minor or mentally incapacitated individual.

In an exemplary first embodiment of the present invention, a “purpose of visit” software tool enables a patient to efficiently pre-screen himself prior to an office visit with a health care professional. As used herein, the term health care professional is understood to encompass any provider or advisor of medical or other health-related services, including, but not limited to, a doctor, physician, dentist, nurse, technician, chiropractor, acupuncturist, nutritionist, herbalist, dietician, physical therapist, occupational therapist, nurse practitioner, physician's assistant, nurse-aid, or any other practitioner or health specialist.

FIG. 1 illustrates an exemplary overview of a method, shown generally at 100, according to the first exemplary embodiment. In the exemplary method, a patient 102 provides information to a computer system executing a software tool, as indicated at 104. A software tool, as used herein, can include a software function, program, application, or otherwise any computer-executable routine. The medical symptom may, for example, be a condition that has prompted the patient to seek advice of a physician, or to seek advice of an exemplary system for managing healthcare as described herein. Upon receipt of the medical symptom by a computer executing the exemplary software tool, the software tool compares the symptom to medical information stored in a medical database 106. Medical database 106 may contain information including, but not limited to, the patient's medical history and personal data. According to the comparison, the software tool then generates a query to patient 102, as indicated at function 108. Specifically, function 108 operates by combining the symptomatic information received by the user at 104 with the personal data and patient history contained in medical database 106 to generate a customized query to the patient which is able to precisely target further required information. For example, if the symptom is a cough, the query may prompt patient 102 for information such as length of the cough, severity of the cough and associated symptoms such as fever or congestion, runny nose and sneezing, sore throat and the like. Examples of other query symptoms could include, for example, lower back pain, joint pain, stomach ache, chest pain, headache, fever, dizziness, insomnia and other common patient complaints. The information is, of course, not limited to these examples. However, the information is utilized by the exemplary method in a process to generate personal guidance to the patient. Once the patient has provided the information, as indicated at arrow 110, the software tool compares the information to a second medical database 112. A second medical database may, for example, contain data such as medical standards data, routine or preventive health care guidelines, or screening, immunization/prophylaxis, counseling or treatment guidelines known in the art and available for example from the United States Public Health Service (e.g. the United States Preventive Services Task Force which routinely publish updated guidelines for health care).

Additionally, or alternatively, a second medical database may contain preventive medicine or wellness guidelines such as those published by various medical or health organizations, for example, the guidelines published by the American Diabetes Association (Alexandria, Va.), the National Library of Medicine (URL:http://text.nlm.nih.gov.; which contain a database of health services/technology assessment information), the National Guideline Clearinghouse (URL:http://textnlm.nih.gov/nge.html; which contains information and links to various clinical guidelines and guides to preventive services developed by the Agency for Health Care Policy and Research (AHCPR) of the Department of Health and Human Services which routinely and systematically “develop statements to assist practitioner and patient decisions about appropriate health care for specific clinical circumstances”) as well as other web-based library resources for up-to-date evidence-based clinical practice guidelines (URL:www.guideline.gov) each of which is hereby incorporated by reference in their entirety.

A second medical database may also include any other types of medical information such as diagnostic data, related symptoms, treatment data, medical history and the like or may be linked to a source of medical standards information, such as (but not limited to) a internet type hyperlink. Upon completion of the comparison, the software tool analyzes the results and formulates personal guidance 114 personalized for the patient. For example, upon comparison and analysis, the guidance can include one or more advice or advisory objective specific to the user. The personal guidance includes personal guidance formulated so as to comprise advice unique to the user's particular input information and/or combination of personal data and medical or health history. It is to be understood that the databases described herein include open directory or open source type databases as well as Web directory type databases. Thus, a personal guidance is one or more advice or advisory objective that is non-generic and customized to criteria specific to the user. As such, one skilled in the art would understand that a customized personal guidance or computer-implemented advice output for one user differs from the guidance or advice output provided for a second user.

Another feature of the present invention is that the personal guidance may comprise a visit report, generated by the exemplary software tool for the benefit of the health care or medical professional. The visit report may conform to a standardized format selected, for example, by the health care specialist, to assist the health care specialist in rapidly reading and analyzing the report prior to examining the patient. The visit report can also be used as an agenda to direct the course of the visit, ensuring that all of the patient's concerns are addressed in timely fashion during today's increasingly brief provider encounters. The visit report can include, but is not limited to, current symptoms being experienced by the patient, the medical history of the patient, past family medical history of the patient, possible diagnoses, recommended tests or procedures, and care or advice to be rendered by the health care professional. The visit report might also include recommended procedures unrelated to the patient's current symptoms, but may include routine and preventive procedures for which the patient is due based upon an analysis of his/her medical history, age, demographics, lifestyle, family medical history or other relevant health or medical diagnostic indicator, and compared to a database of the latest evidence-based medicine standards for such care as promulgated by academic medical societies and/or the government, or other such organizations or resources known in the art or described herein. The report can also include any other concerns or questions the patient may wish to discuss with the provider. The patient can prioritize all of the reasons for the visit to ensure that, in case of a shortened visit or inadequate visit time, the highest priority reasons are addressed first. In addition, reports encompassing information pertinent or related to follow-up visits may also be generated for a patient. Therefore, the system can also provide additional beneficial features to a patient such as scheduling, prompting for and recordation of visit and follow-up visit reports. Such recommendations assist both the patient and the health care professional to manage the patient's health care in an extremely reliable, consistent and efficient manner.

Of course, it is anticipated as being within the scope of the present invention that the databases utilized in the exemplary embodiments may, in fact, comprise a single database of medical information. Also, a patient may be required to enter his/her medical history only once, during his/her first use of the exemplary software tool. Thereafter, the medical history can be retrieved by the software tool from the database, and the patient would need only to provide updated information. Of course, subsequent to each use of the software tool by the patient, the information provided by the patient is automatically stored and the patient's medical information, hereinafter “patient profile,” is updated and stored for subsequent use. Although used primarily from a patient-centric perspective, it is within the scope of the present invention, if desired, that a patient or individual may allow access to or retrieval from the database, information that may be useful to a physician, specialist, practice group, health care payer, health care provider, or any other group or individual to aid in the treatment or management of the patient's health or care.

Aside from symptomatic and medical history information, the exemplary software tool may also utilize other information to perform analyses and to generate personalized guidance to the patient. For example, a patient's demographics can be utilized by the software tool to generate recommended procedures and health care routines. For example, while the analysis for a 50 year old male patient may include an inquiry to the patient's medical history for determination of the most recent prostate cancer screening, an analysis for a 50 year old female could alternately include an inquiry to her medical history for determination of her most recent mammogram. Similarly, the software tool may operate on the medical history of a variety of patients falling within different demographic categories to establish need for and recommend preventive measures for which the patient is due. Chronic illnesses are another example of patient information that is analyzed by the exemplary software tool. For example, a user with heart disease may cause the software tool to generate recommendations for diagnostic studies, cholesterol checks, diet management, and the like. Similarly, a diabetic may be analyzed by the software tool such that a recommendation for periodic blood tests such as for hemoglobin A1c level, eye exams for diabetic retinopathy, and foot exams for diabetes related neuropathy and vascular disease and the resultant sores or ulcers are all performed on a regular and timely basis according to the latest guidelines as promulgated by the appropriate medical societies or public health organizations is generated. Such organizations include for example, but are not limited to, the U.S. Task Force (part of the U.S. Public Health Service) who publishes a wide range of guidelines for screening, immunization/prophylaxis, and counseling; and the American Diabetes Association, which publishes similar information for diabetes, or any other organization or resource known in the art or described herein. Of course, most other medical specialty organizations publish guidelines for diseases in their field as well, and will be utilized in the operation of the present invention. The software will similarly allow patients with other common chronic diseases or disorders such as hypertension, asthma, emphysema, cancer in remission, chronic low back pain, etc. to adhere to the latest medical standards for care and monitoring of their conditions, since the tool's databases will be regularly updated with the latest in such standards. Of course, many variations and possibilities are anticipated and considered to be within the scope of the present invention.

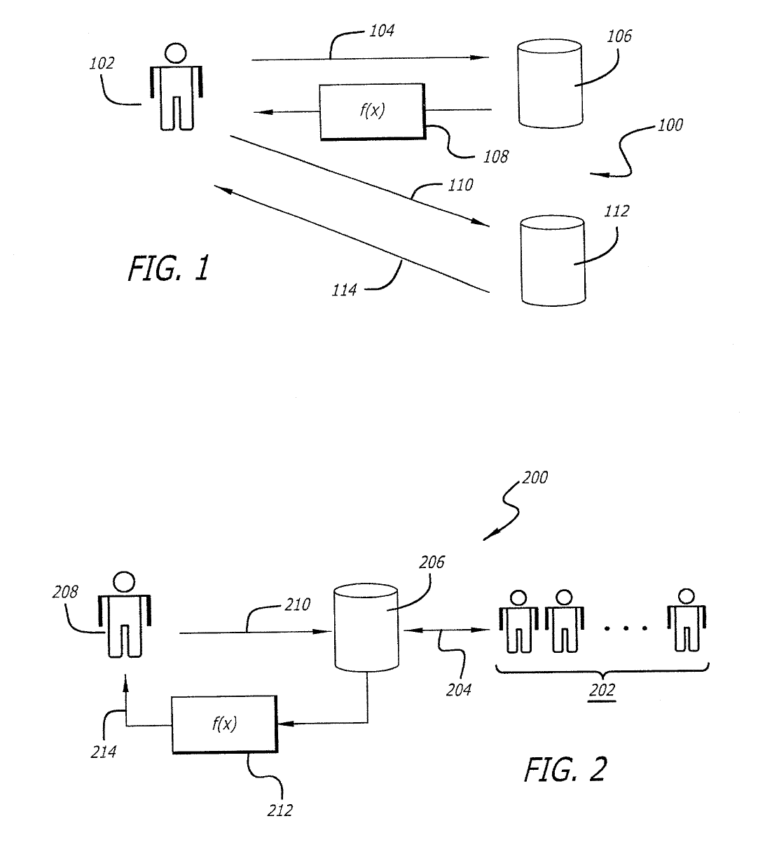

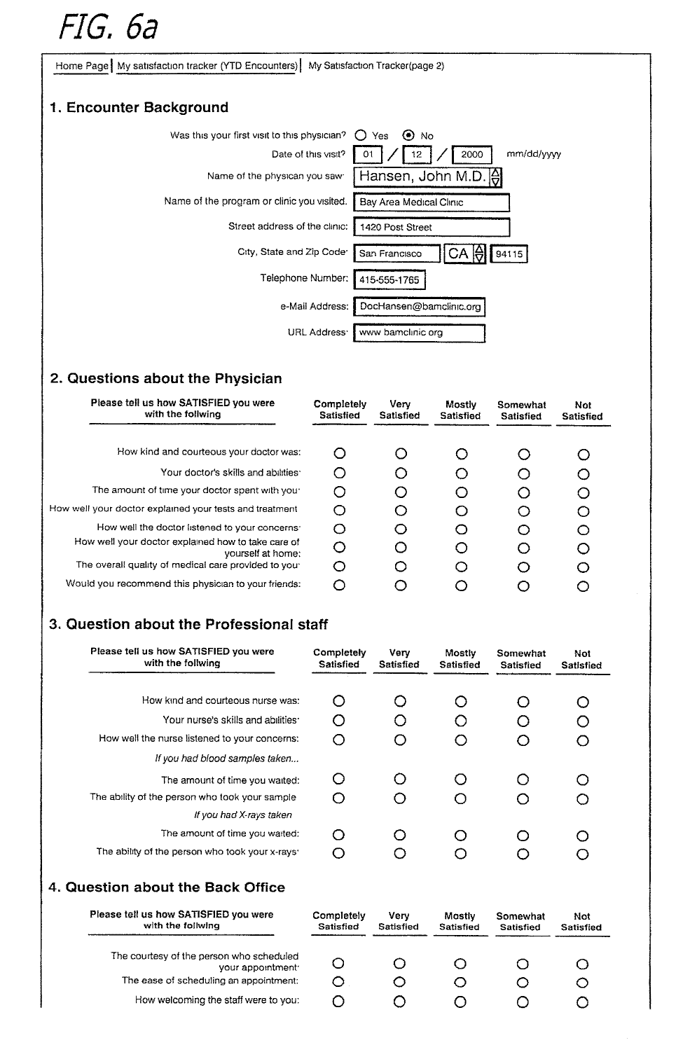

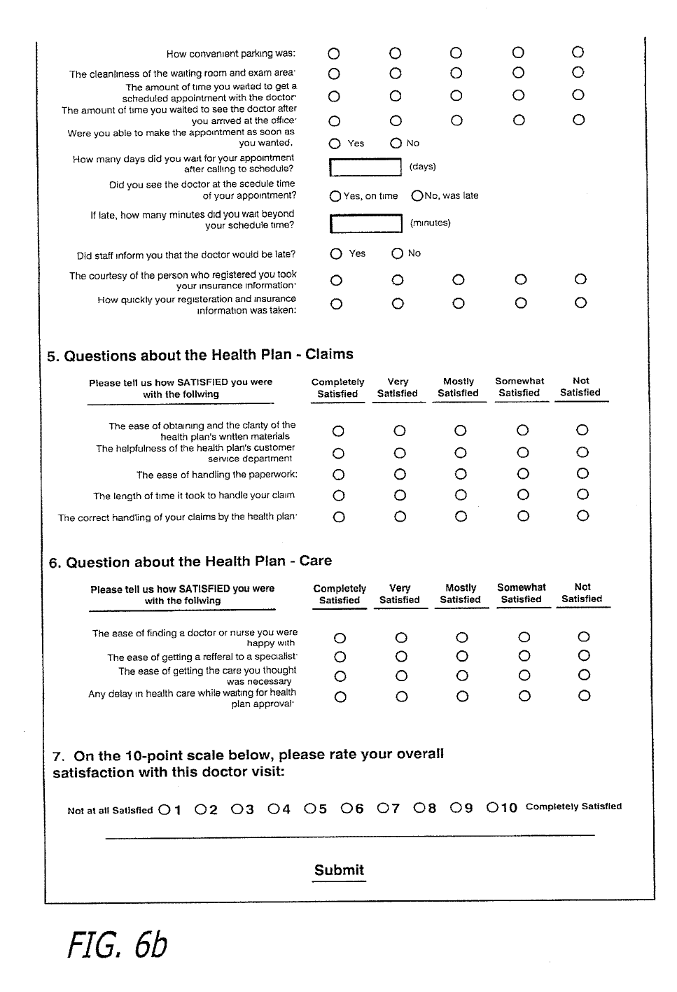

A second exemplary embodiment of the invention, illustrated in FIG. 2, is a method for recommending a health care professional to a patient, and comprises a variety of features shown generally at 200. The exemplary patient satisfaction software tool operates to collect and store information about health care professionals or specialists from a plurality of patients 202. The information is ideally collected immediately following the patients' 202 encounters with a health care professional, specialist, practice group or other health related personnel. The collection mechanism may be, for example, a survey format from which data can be subsequently entered into a database 206 as shown at arrow 204. Alternatively, the information can be entered 204 into storage directly by patients 202 such as through a computer terminal or other electronic or software processing device located, for example, in the health care professional or specialist's office and networked to a centralized remote database. A user can thereby track his/her satisfaction over time with specific providers, and better plan who they would like to use for medical services in the future. They may also use the results of specific questions, such as in timeliness of visit or cleanliness of the facility etc. to make constructive criticisms to the provider in order to improve satisfaction over time. FIGS. 6(a) and 6(b) illustrate exemplary types of queries of a representative encounter by a user when using one aspect of a satisfaction tool.

Referring back to FIG. 2, after the information is established and stored in database 206, or any other storage facility such as, for example, a hard drive or portable computer-readable storage media, the patient satisfaction software tool operates to query an inquiring patient 208 regarding criteria for selecting a health care professional. Inquiring patient 208 provides a computer executing the patient satisfaction software tool with personal selection criteria information, as indicated at arrow 210. The personal selection criteria information may include, for example, timeliness, courteousness, quality of care, and responsiveness attributed to the health care professional. That is, inquiring patient 208 may provide information for the patient satisfaction software tool to recommend a health care professional according to the quality of care generally attributed to the health care professional by plurality of patients 202. As used herein, the term “health care professional” is not limited to those individuals providing medical or health treatment but may also include related individuals, for example, such as support staff, medical office personnel, or any individual and the like who either directly or indirectly interacts with a patient prior to, during or subsequent to a visit. In addition to providing personal selection criteria, inquiring patient 208 can rank his personal selection criteria. For example, if inquiring patient 208 desires a health care professional who is timely, but even more so desires the health care professional to deliver a high quality of care, he can provide timeliness and quality of care as two personal selection criteria, but also inform the patient satisfaction software tool that the quality of care criteria should be weighted more heavily than the timeliness criteria. In addition if an inquiring patient desires to find a provider who ranks particularly high in satisfaction among patients with similar medical histories or conditions as the inquiring patient, then he/she can select that to be among his/her personal selection criteria.

After receiving input from inquiring user 208, the patient satisfaction software tool calculates a satisfaction rating for all health care professional listed in database 206. The satisfaction rating may be calculated by any of a number of conceivable algorithms, as indicated at 212, but will generally be a function of data collected by plurality of users 202, personal selection criteria provided by inquiring user 208, and priority of the personal selection criteria. Upon calculation of satisfaction ratings for the health care professionals, those having the highest ratings are recommended to inquiring patient 208, as indicated at arrow 214.

Of course, many advantages are achieved by the patient satisfaction software tool. This is a powerful tool for patients or individuals to obtain solid recommendations of health care professionals that has thus far been unavailable. No longer will patients be confined to receiving recommendations based solely on location of the office or on word-of-mouth. With the patient satisfaction software tool, patients are able to search for a health care professional or practice group who has particular experience with and ranks high among similar types of patients, with certain traits considered desirable to inquiring patients, or who is particularly well-liked among a particular demographic.

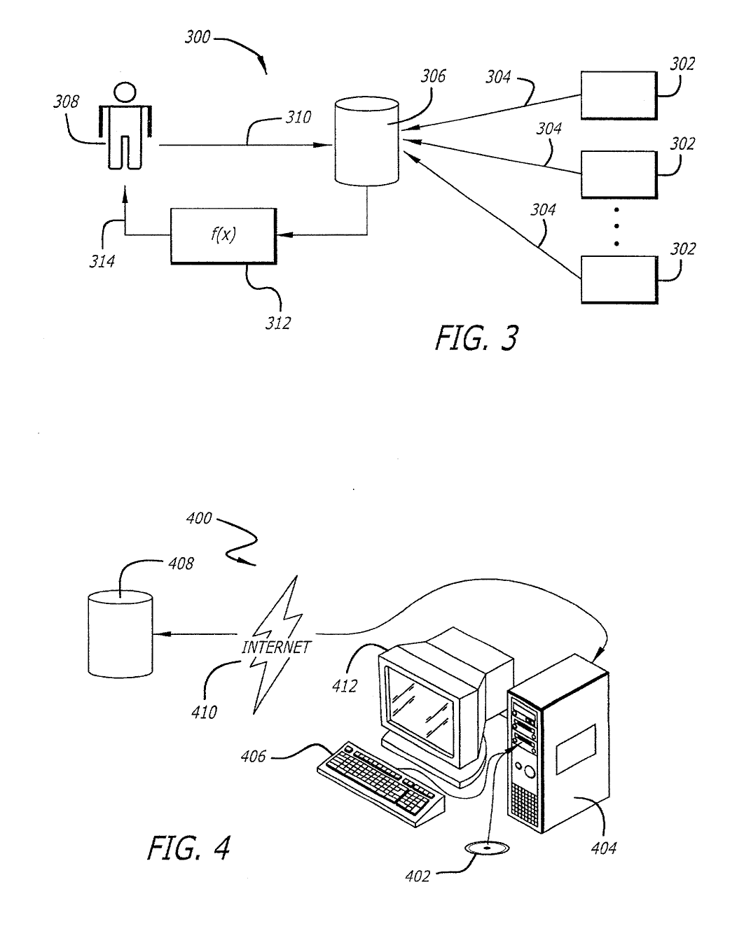

A third exemplary embodiment of the invention is an insurance calculator software tool. FIG. 3 illustrates exemplary features of the insurance calculator software tool, shown generally at 300. The insurance calculator software tool is used to optimize a patient's selection of healthcare insurance. A plurality of healthcare insurance policies 302 and their associated benefits, costs, reimbursement policies, rules, and other regulations, are retrieved as shown at arrows 304 and stored in computer storage, such as database 306. Patient 308 provides medical financial data, as shown at arrow 310, to a computer executing insurance calculator software tool. The medical financial data may include, for example, medical expenditures that have occurred over a period of time. Such information may be updated frequently by the user, or perhaps entered at a single point in time. Once entered, the information may, of course, be maintained for future access. Insurance calculator software tool then compares the medical financial data to the healthcare data, such as with database 306. As indicated at function 312, insurance calculator software tool applies the healthcare data, including the associated benefits, rules and regulations of the plurality of healthcare insurance policies 302, to the patient's medical financial data to calculate the benefit under each of the plurality of healthcare insurance policies 302. Function 312 then compares the benefits, and reports to patient 308, as indicated at arrow 314, which insurance policy or policies would or would have provided the greatest benefit for the particular medical financial data. This analysis, though predicated upon historical medical financial data, is a valuable tool for patients in selecting health insurance policies for the future. Also, patient 308 may provide the insurance calculator software tool with estimates of future needs and future medical expenditures, and this future-related data may be incorporated into function 312 to determine the insurance policy having the greatest benefit to the patient for future needs.

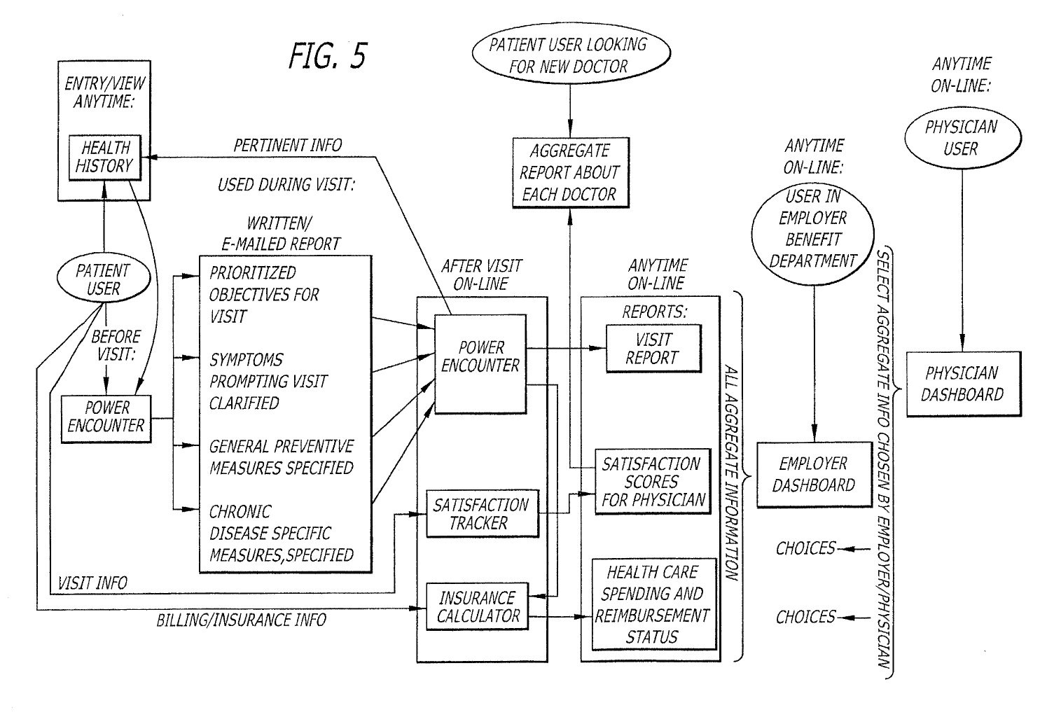

Of course, the present invention also includes systems for executing the exemplary software tools described above. An exemplary system is illustrated in FIG. 4, generally at 400. Although the exemplary software tools may be stored upon any type of storage device or storage medium, the exemplary software tools may also be stored on, for example, portable computer-readable media 402, such as floppy disks, tape, or optical storage media; the software tools may also be stored on a computer hard drive 404 or on remote storage, such as in a database resident on a remote server 408 accessible over Internet 410 or other communications network. Patients and other users of the exemplary system interact with the software tools by an input device 406, which may include but is not limited to computer keyboards, graphical user interfaces operable by mouse or touch-screen, voice activation, or telephone touchtone input. The exemplary system further comprises a computer display device viewable by the user. Although the computer display device may be, for example, a video monitor 412, it could also be a printer capable of producing printed or electronic reports and the like. Additional features which are exemplary of the present invention are illustrated in FIG. 5.

The foregoing description of certain embodiments of the invention has been presented for the purposes of illustration and description. It is not intended to be exhaustive or to limit the invention to the precise form disclosed. Many modifications and variations are possible in light of the above teaching. For example, the following is a partial list of additional and other tools that may be utilized within the scope of the present invention.

Report Card Tool—This tool evaluates health status and risks (i.e. a health risk assessment) that uses the information in the user's health history, prompts the user to put in additional information on some sort of scheduled basis (again according to the need suggested by the past medical history), and suggests steps for improvement. The specific questions asked and the frequency of prompting the user to fill out the assessment and take corrective actions are dependent on the user's specific needs.

Satisfaction Improvement Tool—This tool provides recommendations to a user of how to improve satisfaction with providers, based on the areas of the Satisfaction Tracker that show consistent dissatisfaction by the user. For example, if a user is consistently dissatisfied by providers in a specific area, perhaps the user needs to make changes in the way he/she interacts with providers.

Pharmacist Tool—This tool operates as a medicine, pharmaceutical drug, prescription or other chemical remedy manager. The Pharmacist tool keeps track of the medicines, prescription OTC, and/or supplements that and individual or a family takes. It gives an estimation of compliance and can prompt for refills to improve compliance. It can also tie in to a medical insurance tool and/or a savings account tool to give information on whether a drug or supplement is covered by insurance, and can suggest formulary alternatives or less expensive drugs that may suffice. It can also operate as a pharmaceutical benefits manager for an individual or family. It can also deduct cost of purchased medicines from a medical savings account or other specified account in the savings account tool.

Lab Tracking Tool—This tool is a diagnostic or laboratory studies tracker that can keep track or keep an account of various diagnostic tests performed, the location performed and/or their results. It can also, if desired, be able to download information from various laboratories, medical offices and/or other testing facilities where stored in digital form. Alternative methods of inputting laboratory or medical results information can also be utilized if preferred or desired, depending upon the specific capabilities and/or services of a diagnostics or other facility. It organize reports and graphs for the patient and/or his provider showing trends in tests like such as cholesterol, pap smears, mammography, metabolic panel, etc.

Health Advising Tool—This tool can generate educational materials for a user automatically, based on the results of a provider encounter. It can query a database or databases to find patient information matching keywords of tests, symptoms, drugs, etc. that result from an encounter. This can occur before or after an encounter as desired and selected by a patient or other individual.

Medical Records Tool—This tool can operate as a central index or table of contents that keeps track of where a patient's medical records are located (i.e. in which doctor's offices, hospital(s), or other healthcare provider or healthcare benefits provider or manager location). Upon request from the patient, the eHMO sends out requests for copies, and stores them in a secure central location. These can be imaged so that a patient can access them at any time on line.

Medical Equipment and Supplies Tool—This tool allows purchasing and selling of new and/or used medical supplies or other equipment between consumers, suppliers, payers, providers or manufacturers. It prompts the user to consider, for example, specific durable medical equipment (DME) or other supplies for their needs, based on the outcomes on specific encounters, the patient's previous medical history, and specific inquiries by the user. It can connect to the health benefits tool and the medical savings account tool, to track costs, apply payments to a MSA or other separate account, query an insurance database to check on coverage, complete an insurance claim form, and, if desired, submit the form to an insurance company electronically.

Pregnancy and Fertility Health Care Tool—This tool can help an individual or couple manage or track fertility and/or pregnancy. For example, it can help monitor the menstrual cycle of an individual or family member and predict fertility, ovulatory periods or other information relevant to a couple's fertility assessment. It can also keep track of progress of a pregnancy, such as monitoring gestational age, developmental milestones of the fetus, appropriate weight gain as well as prompting for recommended interventions, nutritional assessment, or other type of gestational health assessment.

Genetic Advising Tool—This tool prepares patient for genetic counseling sessions. The tool can review personal and family history that is available, for example, in the health history tool, and counsel as to whether genetic testing is in order or suggested for specific conditions. The eHMO will update the central database of new genetic tests regularly, so a family is notified when new tests that are pertinent to their family history, or an individual's age or demographics are available. It also is able to evaluate a patient's genetic profile when available in the future from genomic research and/or biotechnological or other testing methods, and predict which treatments or drugs may be most useful or what special screening tests or screening intervals with present tests are recommended given the genetic predisposition or health of an individual. It is the family's key to the future of genetic-based medicine, as it relates specifically to an individual, a couple or a family's needs.

Medical Savings Account Tool—This tool maintains a patient and/or family medical savings account or other separate account. It can ensure that the correct amount of money is deducted from each person's salary as well as keep an ongoing balance. Payments for various health related services are monitored and tallied. It can also, if desired. be able to communicate with various software applications, such as, for example, Quicken, Microsoft Money or any other financial management program or institution. Alternatively, in conjunction with a eHMO credit card, the tool can automatically tracks all health care related expenses. It is also envisioned that such a tool could compile and tally the information and submit the reimbursement electronically to a manager of a Medical Savings Account.

Acute Illness Self Care Tool—This tool can be used in conjunction with or to augment personalized guidance or a PowerEncounter and can allow a patient to safely engage in self-care. It will also remind patient to maintain the suggested and agreed upon interventions and will track the course of the acute illness under self-care. It will prompt the patient to see if any new or more worrisome signs or symptoms have manifested and will suggest any changes in the self-care regimen or whether self-care should be abandoned and professional help sought. It can provide a diary of self care measures employed that will feed back into the personalized guidance or PowerEncounter.

Chronic Disability Self Care Tool—This tool functions like the Acute Illness Self Care tool, except that the focus is on long term disabilities and chronic disease versus acute illnesses.

Independent Living Tool—This tool is an aid in helping a temporarily or a permanently disabled or handicapped individual determine or select individualized home care needs such as type of walker, wheelchair, nursing care, or other durable medical equipment, or determine level or degree of home health care need such as nursing care, occupational therapist, speech therapist, nutritionist, or assisted living care. It can document the need and can tie into a Health Benefits tool to submit reimbursement forms

Appointment Making Tool—This tool confirms, tracks and keeps appointments organized. For example, a patient needing an appointment for a physical. An appointment request can be sent to a doctor's office or other scheduling. This tool automatically requests an appointment and keeps track of scheduled appointments. Multiple requests can be sent to more than one physician or health care provider or any other system used to track and calendar scheduled appointments in the provider's system. The appointment making tool can be designed to interact with the patient's own calendaring system such as Microsoft Outlook or a Palm Pilot calendaring software and therefore, take into consideration other scheduled events that need to be docketed or coordinated around.

Additional tools contemplated as being within the scope of the present invention are include, for example:

ADL Assessment Tool—This is tool to help an individual assess ADL insufficiencies. These insufficiencies often trigger coverage for long term care insurance. A self-assessment tool that also uses the patient's past medical history may suggest when such long term care and reimbursement may begin, or may need to be professionally assessed. This would help the user maximize the potential benefits of long term care insurance.

Hospital Stay Tool—This tool helps plan for, evaluate, and improve a hospital stay based on the patient's past medical history and past experiences with hospital stays. Specific areas that the patient was unhappy with before will be suggested in advance for improvement.

Home Care Tool—This is a tool to help plan for, evaluate, and improve the satisfaction with the use of home health care (same as above but for home care episodes).

Nursing Home Tool—This is a tool to help plan for, evaluate and improve the use of a nursing home (same as above but for nursing home care episodes).

Exercise Manager Tool—This tool helps plan for, evaluate, and track exercise activities. This is a goal-oriented program that will input the information on exercise type, frequency, and duration into the patient's permanent health history. The amount of exercise and success with meeting goals will be summarized when the user visits his/her provider, such that patients who need to exercise, but are having trouble sticking to a program, will be identified to the provider. The provider would be able to recommend methods to improve compliance with exercise recommendation to improve compliance. This is especially important for those with certain chronic disease like diabetes and hypertension, where regular exercise can delay or help to avoid the onset of specific medical complications.

Stress Manager Tool—This is a self-assessment tool to track the level of stress in a patient's life and suggest ways to reduce and or cope with it. It will take the patient's health history, including amount of exercise, medications being used etc. into account and make a recommendation for contacting outside professionals for help in stress reduction when certain risk factors appear. These risk factors may be specific answers to questions recommended by general medical guidelines. Some of the answers to these questions may be already in the patient's health history, thus making the tool more efficient than simply filling out a self-assessment from scratch.

Mental Health Manager Tool—This tool helps evaluate, manage, and track mental illnesses such as depression, much as the other tools track the progress and treatment of other chronic disease. Users will be prompted for periodic self-assessments based on specific needs. As with the other tools, a recommendation for seeking outside help will be suggested when certain signs or symptoms appear or remain for specified times according to established medical guidelines.

First Aid Tool—This tool guides individuals in the necessary steps of first aid for a given situation

Safety and Prevention Manager Tool—This is a tool that suggests safety and accident prevention methods for an individual or family based upon their individual needs and medical history

Healthy Vacation Planning Tool—This tool helps a family plan a vacation that benefits the physical and mental health of an individual or family based on their individual needs and past medical history. For example families with members with allergies would be steered away from destinations during those destinations' peak pollen or other allergen period. Families with a member under stress could be steered towards resorts with specific stress reduction programs. Specific accommodations that are allergen-reduced could be suggested in any location. Could tie into an e-business related to travel.

Healthy Time Manager Tool—This is a tool that helps to plan one's daily schedule in the manner that most effectively benefits the health of the user. For example a user who has been told that he/she does not get enough sleep, would be able to input the necessary amount of sleep and that time period would appear unavailable for other activities on the schedule. Similarly, a patient for whom an exercise program has been recommended, would schedule that time, and it would appear as an inviolable appointment on the calendar. Could work together with software calendars either PC-based or web-based. Results would be kept in the health history.

Healthy Reading Guide Tool—This is a tool that suggests reading materials that will help an individual or family depending on their specific medical needs and experience. It could be linked to a database of new and current books, so that as new books are published in areas that the family has needs in, the family is prompted. The book could be ordered on-line directly from the e-HMO, using some sort of agreement with an on-line bookseller.

Health Job Finder Tool—This is a tool that will help an individual select the work or profession that would most benefit their specific health status and needs. This will specifically look at the environment and activities of certain jobs, and help to steer users away from jobs that could be unhealthy to them. For example, a teenager with a family history of cancer could be told to avoid a job at a gas station or as a lifeguard. Users with frequent periods of stress could be steered towards less stressful positions or industries, according to survey and other available data. Could be linked to an online career aptitude test, but the results would be modified according to the specific health history.

Hospital Locator Tool—This is a tool that helps locate the nearest hospital with good results and quality in areas of health care that are most likely to be needed by an individual or family. This would also function like the Satisfaction Tracker described in the main part of the application, except would work for the hospital, rather than the provider. It would allow users facing a hospitalization to find a hospital that ranked high in satisfaction among others who had the same operation, and/or same priorities in satisfaction parameters.

Anonymous Advice Seeking Tool—This tool seeks and deliver anonymous advice on specific health issues and questions, protecting the identity of the individual, and prompted by the past medical history of the user.

Travel Medicine Guide Tool—This tool advises on specific needs and recommendations prior to travel to foreign countries based on individual and family health history and needs.

Sleep Assessment Tool—This tool helps to identify individuals' sleep related problems based on their medical history and answers to specific questions. It would use information in the health history to fill in parts of the assessment.

Partner's HealthTool—This tool helps an individual evaluate the health of their spouse or partner, using external signs and symptoms, behaviors, etc. so that a partner could help to identify health problems.

Healthy Menu Tool—This tool helps an individual or family plan healthy meals that are specific for their conditions and past health experience.

Healthy Restaurant Tool—This tool helps to locate restaurants with menus that would cater to My Healthy Menu.

It is intended that the scope of the invention not be limited by this detailed description, but rather by the claims appended hereto. Additionally, this specification contains citations to publications, patents, and sources of publications such as URL addresses and web-based or Internet sites, each of which is hereby incorporated by reference as if fully set forth.

What is claimed is:

1-31. (canceled)

32. A computer-implemented method for managing patient healthcare, the system comprising:
receiving from a user, symptom information and matching the symptom information to primary medical or health information stored in a first database;
based on the user information and the medical or health information, generating at least one query to the user regarding the user's medical state;
receiving from the user personal information in response to the query;
comparing the personal information to secondary medical or health information stored in a second database;
based on the symptom information, the primary medical or health information, the personal information and the secondary medical or health information, generating a computer-based personal guidance customized for the user.

33. The method of claim 1 wherein the personal guidance directs the user to a self-care program.

34. The method of claim 1 wherein the personal guidance directs the user to a health care provider.

35. The method claim 32 wherein the personal guidance includes computer-based advice unique to the user.

36. The method of claim 32, further comprising:
generating a visit report for the benefit of the health care provider, said visit report comprising:
current symptoms of the user;
medical history of the user; or
suggested care to be offered by the health care specialist.

37. The method of claim 36 wherein the visit report further comprises treatments for which the user is due, said treatments identified according to analysis of the prior history of the user.

38. The method of claim 32 wherein the primary medical information comprises information describing a personal medical history of the user.

39. The method of claim 32 wherein the secondary medical information comprises a medical standard, symptomatic data, diagnostic data, or treatment data.

40. The method of claim 32 wherein the first database and the second database comprise a single database.

41. The method of claim 32 wherein the first database and the second database together define a third database.

42. The method of claim 32 wherein the personal information includes demographic information and the secondary medical information includes preventive measures data and wherein the method further comprises:
comparing the demographic information to the preventive measures data;
generating suggested preventive measures appropriate for the user according to the user's demographic information;
and including the suggested preventive measures in a personal guidance.

43. The method of claim 42 wherein the personal information includes medical history data of the user;
wherein the comparing includes comparing the demographic information to the preventive measures data;
and wherein the suggested preventive measures appropriate for the user are further according to the user's medical history data.

44. The method of claim 43 wherein the medical history data comprises chronic illness information; and wherein the suggested preventive measures are directed to the chronic illness information.

45. The method of claim wherein the personal information comprises secondary symptoms not related to the user's symptom information; and wherein the visit report further comprises information related to the secondary symptoms.

46. The method of claim 36 wherein the visit report conforms to a standardized format.

47. A system for managing a patient's healthcare, the system comprising:
a storage device containing medical or health data;
an input device, operatively connected to the storage device, for receiving symptomatic data from a patient;
a computer processor, operatively connected to the storage device and to the input device, for comparing the symptomatic data to the medical or health data, generating a query to the patient regarding personal information related to the patient's current medical state or medical history, comparing the personal information to the medical data, and generating a computer-based advice to the patient.

48. The system of claim 47 further comprising a display for presenting the guidance to the patient.

49. The system of claim 47 wherein the display device is a video monitor.

50. The system of claim 47 wherein the display device is a printer.

51. Computer-readable storage media containing computer software that performs the following functions when executed on a computer:
receives from the user, symptom information regarding a medical or health symptom;
matches the symptom information to primary medical or health information stored in a first database;
based on the user information and the medical or health information, generates a query to the user regarding the user's medical state;
receives from the user personal information in response to the query;
compares the personal information to secondary medical or health information stored in a second database;
based on the symptom information, the primary medical or health information, the personal information and the secondary medical or health information, a customized computer-based advice for personal guidance is formulated for the user.

52. The computer readable storage media of claim 51 wherein the personal guidance includes computer-based advice unique to the user.
